(19) United States
(12) Patent Application Publication
(10) Pub. No.: US 2004/0175166 A1
(43) Pub. Date: Sep. 9, 2004

(54) Intravenous tubing heater

(75) Inventors: Rainer Bartscher, Bad Wunnenberg (DE); Michael Pelster, Warstein-Hirschberg (DE)

Correspondence Address: THE FIRM OF KARL F ROSS, 5676 RIVERDALE AVENUE, PO BOX 900, RIVERDALE (BRONX), NY, 10471-0900, US

(73) Assignee: Transmed Medizintechnik GmbH & Co. KG

(21) Appl. No.: 10/717,432

(22) Filed: Nov. 18, 2003

(30) Foreign Application Priority Data
Nov. 19, 2002 (DE) 10254050.0

(51) Int. Cl. F24H 1/10; H05B 3/78

(52) U.S. Cl. 392/481; 392/494

(57) ABSTRACT

An apparatus for heating or cooling a fluid in flexible tubing has a body generally centered-on an axis and having an outer surface formed with a radially outwardly open helicoidal groove of a cross-sectional shape generally corresponding to a cross-sectional shape of the tubing so that the tubing can be fitted to the groove in heat-exchange contact with the body. The outer surface is tapered axially such that substantially all of the groove can be seen from a point axially offset from the body that is heated or cooled.

### FIELD OF THE INVENTION

The present invention relates to an apparatus for heating or cooling a fluid moving through flexible tubing. More particularly this invention concerns an intravenous (IV) tubing heater typically used for blood products.

### BACKGROUND OF THE INVENTION

Blood products such a erythrocyte concentrate or whole blood are typically stored at between 2° C. and 6° C. and are at most room temperature of about 20° C. by the time they get to the patient. Before the liquid can be infused into the patient, however, it must be warmed to close to body temperature, that is to between 35° C. and 37° C. When dealing with major surgery or serious injuries in a patient of, say, 70 kg, it can be necessary to infuse at a rate of up to 105 ml concentrate per minute, and this volume must be heated from about 4° C. to body temperature before it is infused.

This job is typically done by installing a heater as well as the standard peristaltic pump along the tubing that runs from the bag suspended some 1.5 m to 2.0 m off the floor at the top of an IV rack to the needle in a vein of the patient. Such a heater, as described in German patent document 197 40 177 of W. Pieroth, comprises a cylindrical support centered on a horizontal axis and fixed to the IV rack below the blood bag. The cylindrical surface of this support is formed with a spiral groove of part-circular section. The groove is undercut to hold the tubing. The drum is maintained by an internal electric heater at about 36° C. and heats the blood by conduction through the wall of the tubing.

In order to heat the blood to a fast IV drip as described above, it is necessary to wrap some 3.5 m of tubing around the heater. Since the drum can only be so large, it is therefore necessary in practice that the tubing be looped about nine times around the drum. The groove is undercut so that the user must press the tubing along its entire length into the groove.

As a result of the orientation at or below eye level of the heater drum, it is therefore necessary that the user meticulously feel around the drum as the tubing is installed and, normally, also watch the process by stooping each time the tubing passes underneath the drum. This is obviously a laborious and uncomfortable job, one that frequently must be done under emergency conditions when the nurse in charge of the IV could be more efficiently employed.

### OBJECTS OF THE INVENTION

It is therefore an object of the present invention to provide an improved apparatus for heating a fluid in flexible tubing.

Another object is the provision of such an improved apparatus for heating a fluid in flexible tubing which overcomes the above-given disadvantages, that is which is easy to use.

### SUMMARY OF THE INVENTION

An apparatus for heating or cooling a fluid in flexible tubing has a body generally centered on an axis and having an outer surface formed with a radially outwardly open helicoidal groove-of a cross-sectional shape generally corresponding to a cross-sectional shape of the tubing so that the tubing can be fitted to the groove in heat-exchange contact with the body. The outer surface according to the invention is tapered axially such that substantially all of the groove can be seen from a point axially offset from the body that is heated or cooled.

Such a tapered surface gives several advantages. First, it allows the person fitting the tubing to the groove to stand in one position and watch the entire operation. There is no need to keep changing point of view since the entire outer surface of the drum can be seen. In addition the tapered surface ensures that the tubing can easily be fitted to the drum very easily by first carefully fitting it to the innermost end of the groove, that is the end nearest the larger-size end of the surface, and then looping it tightly around the drum so that it automatically slips down the tapered surface to drop into the next empty turn of the groove. Furthermore if the drum is to be covered after it is fitted with the tubing, the tapered shape allows a simple sleeve-shaped cover to be set in place, eliminating any need to wrap a cover and secure it.

The outer surface is substantially frustoconical. It is also possible to be a pyramidal frustum, or even by of elliptical or oval shape. Under any conditions the surface is tapered, that is formed of a family of lines that extend axially and converge radially.

The groove is of part-circular section so that it conforms and forms a good heat-exchange surface with the circular-section tubing.

A clamp is provided for mounting the body to an IV rack with the axis generally horizontal. In addition an annularly continuous insulating sleeve of a shape substantially identical to that of the outer heater-body surface can be fitted over the body once the tubing is fitted to its groove to conserve heat and make the system more efficient.

### BRIEF DESCRIPTION OF THE DRAWING

The above and other objects, features, and advantages will become more readily apparent from the following description, reference being made to the accompanying drawing in which:

FIG. 1 is a partly sectional and partly schematic view of the IV-tubing heater according to the invention;

FIG. 2 is a smaller-scale side view of the heater;

FIG. 3 is a largely schematic view illustrating how the tubing and heater groove interfit;

FIG. 4 is a view like FIG. 3 but showing how the tubing automatically seats in the groove;

FIG. 5 is a view like FIG. 1 but with an insulating sleeve in place; and

FIG. 6 is a large-scale sectional view of a detail of FIG. 5.

### SPECIFIC DESCRIPTION

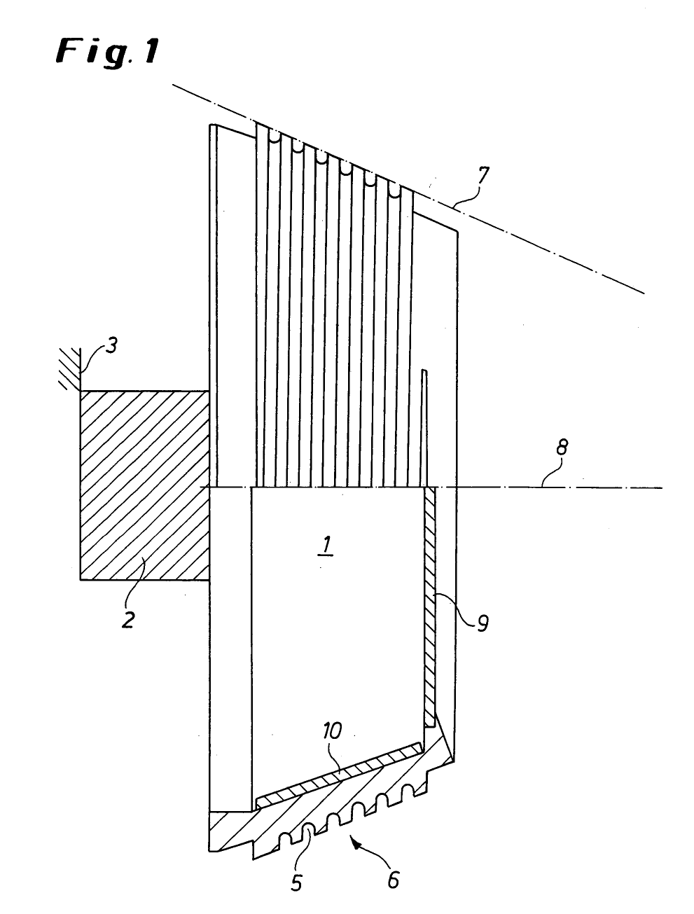

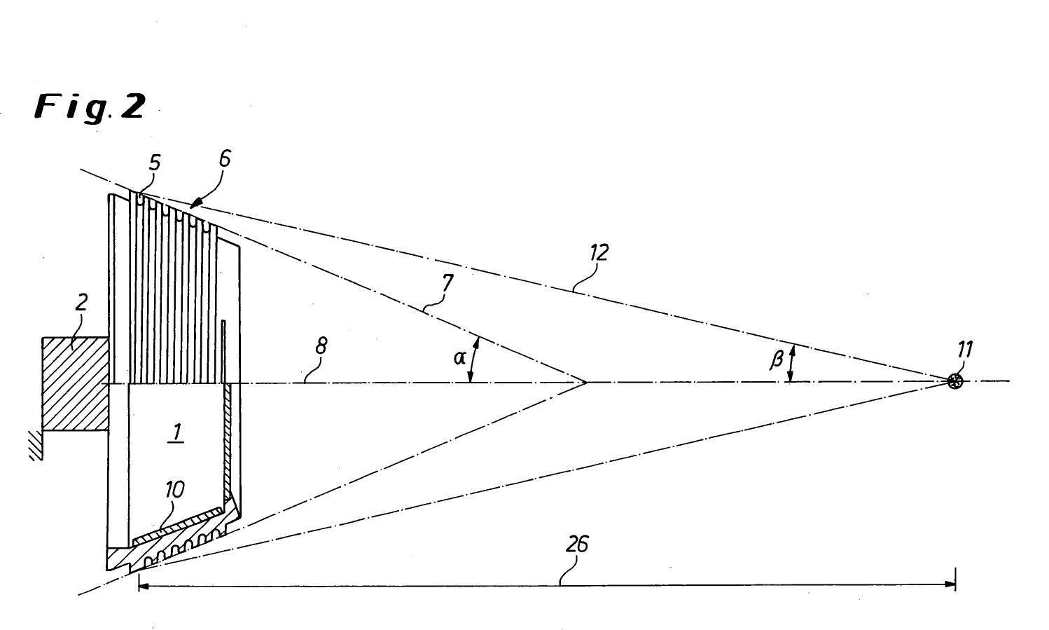

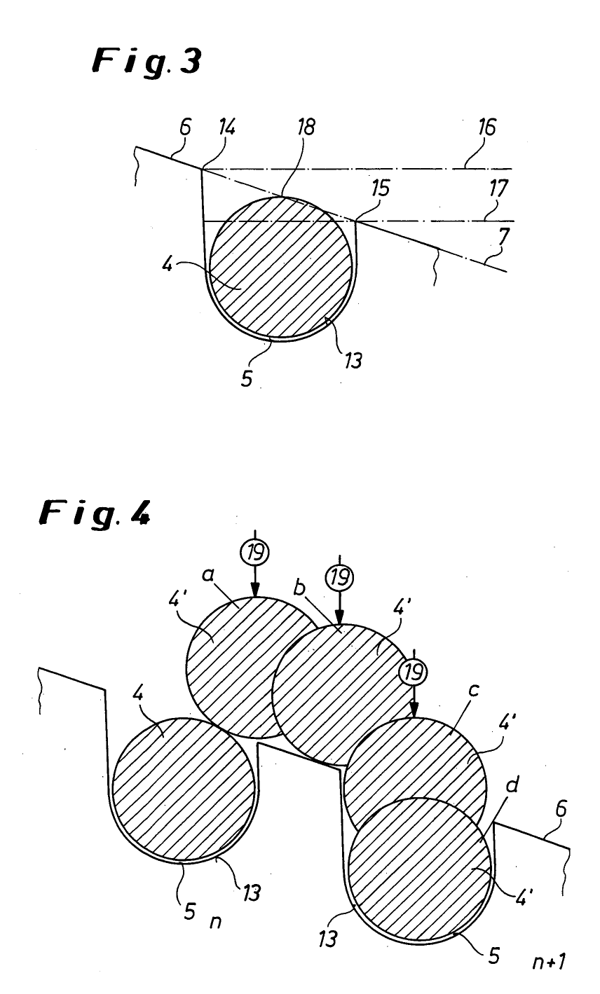

As seen in FIG. 1 an IV-tubing heater according to the invention basically comprises a cast metal body 1 securable by a clamp 2 to an IV stand shown schematically at 3. The heater body 1 is centered on a normally horizontal axis 8 and has a frustoconical outer surface 6 formed with a helicoidal and radially outwardly open groove 5 described in more detail below and intended to hold turns of an IV tubing 4 (FIGS. 2 and 3). The body 1 is basically tubular and is provided internally with an electrical heating foil 10 whose temperature is indicated at a display and controlled by a keyboard on an end panel 9 closing the small-diameter outer end of the body 1.

As best shown in FIG. 2, the outer surface 6 is tapered such that a family of lines 7 that meet at the axis 8 form an apex angle α of at least 5° and at most 45°. The body 1 is dimensioned and set up such that if spaced by a distance 26 from a point 1 corresponding to the eyes of a person loading a tube 4 into the groove 5, view lines 12 from the point 11 define an apex angle β normally between 5° and 20° that is somewhat smaller than the angle α. As a result every turn of the groove 5 is visible from the point 11. The distance 26 is typically about 50 cm, that is an arm's length, so that the person fitting the tubing 4 to the groove 5 is at a comfortable working distance from the surface 6 and can see all of it without having to move his or her head during the loading process.

FIG. 3 shows how the blood-filled tubing 4, which is of circular section, has a diameter roughly equal to that of an inner wall 13 of the groove 5 which has a radius between 45 mm and 180 mm. The surface 6 meets the turns of the groove 5 at corners 14 and 15 that can be sharp as shown or chamfered or rounded. The angle α and the axial and radial dimensions of the groove 5 and diameter of the tubing 4 are such that a line 16 parallel to the axis 8 and drawn to the inner edge 14 of the groove 5 lies wholly outside an outer portion 18 of the tube 4 fitted to the groove 5. Similarly a line 17 parallel to the axis 8 and drawn to the outer edge 15 of the groove intersects this portion 18. This means that person looking axially at the body 1 can see every turn of the tubing 4 fitted to the turns of the groove 5, being able at a glance to check that the tubing 4 is properly fitted to the groove 5. The visibility of the inner edge 14 makes it easy to verify that the tube 4 is pushed all the way down in the groove 5.

During the fitting or loading of the tube 4 to the groove 5 as shown in FIG. 4, the tapered shape of the frustoconical surface 6 ensures that if the tubing 4,is first fitted into turn n of the groove 5 and then another turn 4′ of it is laid over this filled turn n as shown at position a, tension in the tubing 4 creating a radially inwardly effective force as indicated by arrow 19 will automatically shift this turn 4′ axially outward through positions shown at b and c until it seats at position d into turn n+1 of the groove 5. The tapered shape of the surface 6 therefore not only makes it possible to monitor the fit of the tubing 4 to the groove 5, but this shape also ensures automatic loading of the tubing 4 into the groove 4 once it is started by simply looping the tubing 4 tightly around the surface 6 starting from its large-diameter inner end.

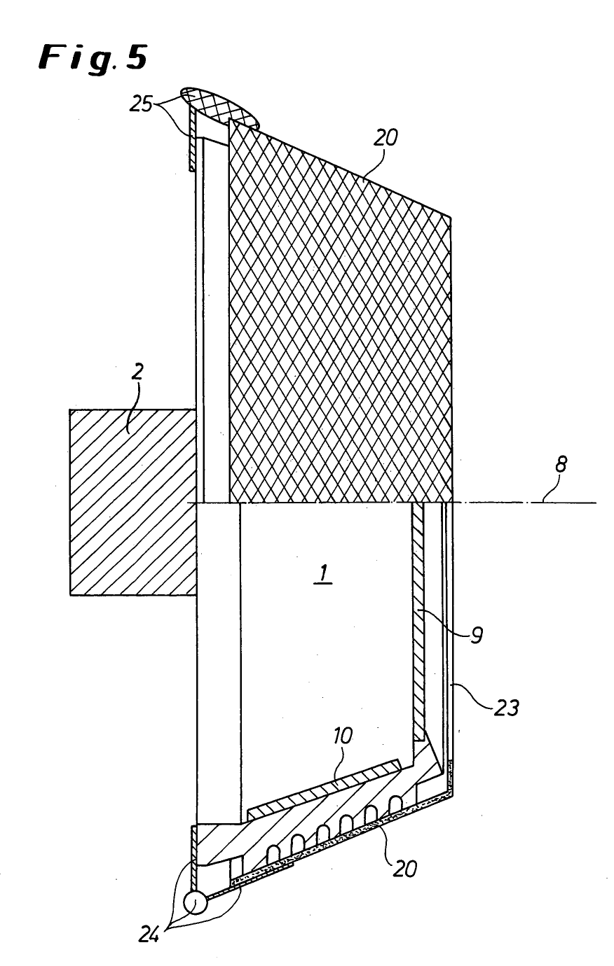

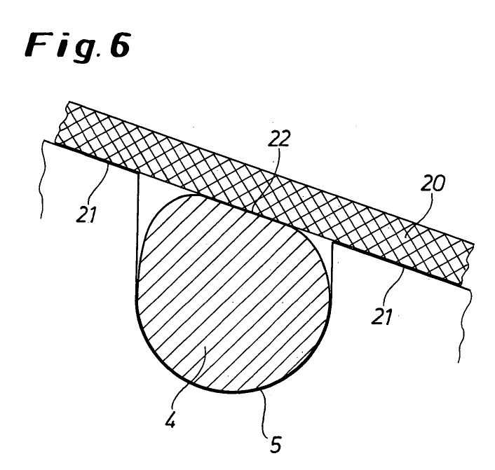

FIGS. 5 and 6 show how a frustoconical and annularly continuous insulating sleeve 20 can be secured to a lower part of the rear end of the body 1 by a hinge 24 and held in place at a top part of the rear end of the body 1 by a flexible catch 25. This insulating sleeve 20 has an opening 23 in its outer end so the display and keypad on the end 9 can be used when it is in place. It has an inner surface 21 that contacts an outer surface 22 of the tubing 4 in the groove 5 so as to secure it in place. The function of the sleeve 20 is mainly to reduce heat loss, increase the efficiency of the heater 10, and ensure that the tubing 4 is fully seated in the groove 5, as if the tubing 4 is lying on the lands between the turns of the groove 5 the sleeve 20 will not be able to fit snugly in place.

We claim:

1. An apparatus for heating or cooling a fluid in flexible tubing, the apparatus comprising:
a body generally centered on an axis and having an outer surface formed with a radially outwardly open helicoidal groove of a cross-sectional shape generally corresponding to a cross-sectional shape of the tubing, whereby the tubing can be fitted to the groove in heat-exchange contact with the body, the outer surface being tapered axially such that substantially all of the groove can be seen from a point axially offset from the body; and
means for heating or cooling the body.

2. The apparatus defined in claim 1 wherein the outer surface is substantially frustoconical.

3. The apparatus defined in claim 1 wherein the groove is of part-circular section.

4. The apparatus defined in claim 1, further comprising
means for mounting the body to an IV rack with the axis generally horizontal.

5. The apparatus defined in claim 1, further comprising
an annularly continuous insulating sleeve fitting snugly over the outer surface and radially outwardly closing the groove.

6. The apparatus defined in claim 5, further comprising
means for releasably securing the sleeve on the surface.

7. The apparatus defined in claim 6, further comprising
a hinge mounting the sleeve on the body.
